(19) United States
(12) Patent Application Publication
(10) Pub. No.: US 2011/0239473 A1
(43) Pub. Date: Oct. 6, 2011

(54) Jig Saw with Saw Blade Holder

(75) Inventor: Marco Zurkirchen, Bubikon (CH)

(73) Assignee: CEKATEC AG, Wattwil (CH)

(21) Appl. No.: 13/139,471

(22) PCT Filed: Oct. 12, 2009
(86) PCT No.: PCT/EP2009/063235

§ 371 Date: Jun. 13, 2011

(30) Foreign Application Priority Data
Dec. 22, 2008 (EP) 08106027.9-2302

(51) Int. Cl. B23D 49/00

(52) U.S. Cl. 30/392

(57) ABSTRACT

The invention relates to a jigsaw (1) having a saw blade receptacle (10) for fastening a saw blade (4) to the jigsaw (1) without a tool. The saw blade receptacle (10) comprises a clamping element (20), a counter piece (30) and at least one wedge (35) operatively connected to the clamping element (20), wherein the clamping element (20) by means of a displacement of the wedge (35) can be moved against a shaft (5) of the saw blade (4) that can be positioned between the clamping element (20) and the counter piece (30). The wedge (35) can be displaced approximately perpendicular to the movement direction of the saw blade (4).

The present invention relates to a jigsaw having a saw blade receptacle.

Different jigsaws which have devices for receiving a saw blade without the need for a tool are already known in the prior art. Thus, for example, EP1964635A2 shows a jigsaw with a saw blade receptacle where the shaft of a saw blade is introduced into the saw blade receptacle in a twisted manner, having then to be rotated into the operating direction. The shaft then lies between two clamping jaws that are wedge-shaped on their outer surface. An additional element that acts on the wedge shape can be displaced by means of rotating a sleeve part in the direction of the reciprocating movement of the saw blade such that the clamping jaws are pressed together by means of the wedge shape and the shaft is clamped on its flat sides.

DE102004042026A1 shows a clamping device for the toolless clamping of a saw blade of a jigsaw. One variant is shown in which the saw blade is fixed on its flat side as a result of a clamping movement of a clamping plate, triggered by displacing a sleeve part with inclined connecting members. An alternative solution shows the clamping plate being displaced by means of lateral movements of a pin on a ramp of the clamping plate.

Some of the known saw blade receptacles are certainly able to accommodate saw blades of different thicknesses, but they are constructed in a very complicated manner. The vibrations that are typical in the case of jigsaws, triggered by the reciprocating movement of the saw blade receptacle and of the saw blade, can unintentionally loosen or even release a clamping of the saw blade. In addition, it is not possible or only possible in a limited manner to operate the saw blade receptacle in every position of the saw blade receptacle.

Further known solutions show clamping devices which clamp the saw blade only on the narrow side and, consequently, are not able to accommodate the saw blade in a play-free manner, which renders precise work with the jigsaw impossible.

It is the object of the invention to overcome the disadvantages of the prior art. In particular, saw blades of different thicknesses are to be accommodated in a simple, secure and play-free manner.

This object is achieved by the devices defined in the independent claims. Further embodiments are produced from the dependent claims.

A saw blade receptacle of a jigsaw as claimed in the invention for fastening a saw blade to the jigsaw without a tool includes a clamping element, a counter piece and at least one wedge which is in operative connection with the clamping element. The term operative connection in this case refers to the fact that the wedge is in contact with the clamping element in the operating position. By means of displacement of the wedge, the clamping element can be moved against a shaft of the saw blade which is positionable between the clamping element and the counter piece. The wedge is displaceable approximately perpendicular to the reciprocating movement of the saw blade and, as a result, said saw blade is not able to be released due to any vibrations occurring thereby. The term approximately perpendicular refers here and below to an angle of 90°+/−5°. In order to obtain additional protection against the unintentional releasing of the wedge, said wedge can be provided with arbitrary means for fixing the wedge in the fixed position. Such means are, for example, a spring, a fixing screw, a locking element or a clamp fit. Other means are equally conceivable.

The clamping element is positioned such that a contact surface of the clamping element is movable against a flat side of the shaft of the saw blade. In this case, the contact surface can have a special contour, for example, it can be designed so as to protrude, in part, in a cylindrical or spherical manner in order to obtain linear or punctiform contact. In addition, said contact surface can have another special surface, in particular a rubber-like coating, a straight knurl or marks, in order to obtain increased friction between the clamping element and the flat side of the shaft. Other developments are equally conceivable. By clamping the shaft on its flat side, the saw blade is fixed such that no play exists transversely in relation to the direction of sawing and cutting work can be carried out in a precise manner. As the wedge allows stepless adjustment of the clamping element, saw blades of different thickness are able to be clamped in a play-free manner.

The clamping element can be fastened on the counter piece so as to be rotatable about an axis. For example, the clamping element can be fastened on the counter piece by means of a pin, allowing for a very simple design of the saw blade receptacle. As an alternative, the clamping element can be fastened on the counter piece by way of a flexible joint. Other variants are equally conceivable.

The axis can extend approximately parallel to the flat side of the shaft of the saw blade in the operating position. The term approximately parallel refers here and below to an angle of 0°+/−5°. If the axis additionally extends approximately perpendicular to the direction of movement of the saw blade, this ensures that the flat side of the shaft of the saw blade is uniformly gripped by the contact surface and consequently is acted upon in a uniform manner by the contact force.

The clamping element can be fastened on the counter piece such that the clamping element is automatically moved into an open position with the wedge pushed away. The advantage of this is that the saw blade receptacle is open and is ready to accommodate or release a saw blade in a force-free manner. Such automatic opening of the saw blade receptacle can be achieved by the clamping element being acted upon by a spring force or interacting with the wedge by means of a guide connecting member.

The clamping element can have, on the side of the contact surface, at least one projection which projects beyond the contact surface. During the clamping of the shaft of the saw blade, said projection engages behind a cam in known saw blades. Said at least one projection is positioned, in this case, such that the cams of known T-shafts or single cam shafts are gripped. It is also conceivable for the projection to be designed such that cams of known double cam shafts can be engaged- behind. In this case it is irrelevant to the invention whether, in the case of double cam shafts, only the lower and/or the upper cams are engaged-behind. It is equally conceivable for the projection not to be arranged on the side of the contact surface, but inside and/or in front and/or behind the contact surface with respect to the reciprocal direction of the saw blade. Consequently, reliable gripping of recesses would be possible, such as are provided, for example, in the case of the so-called “Makita shaft”. Such engaging-behind of the cams or engaging in recesses prevents the shaft being unintentionally torn out of the saw blade receptacle.

To accommodate the shaft better, the counter piece can have a groove-shaped shaft receptacle corresponding to the form of the shaft. The width of the shaft receptacle, in this case, corresponds approximately to the width of the shaft to be accommodated. A certain play of the shaft in the shaft receptacle is not really relevant, as in this case it is play that lies in the cutting direction of the saw blade. It goes without saying that the width of the shaft receptacle, however, is greater than the width of the shaft. Play lying transversely in relation to the direction of sawing is prevented by means of the named clamping of the flat side. The depth of the shaft receptacle corresponds approximately to the thickness of commercially available jigsaw blades. By clamping the shaft on the flat side, saw blades of different thicknesses can be accommodated with a given depth of the saw blade receptacle.

The jigsaw can additionally include an actuating element, which juts out of the housing at a fixed position. The actuating element is designed such that it is movable into contact with the wedge independently of the position of the saw blade receptacle and enables displacement of the wedge. This means that it is possible to replace the saw blade in any position of the saw blade receptacle.

From the prior art GB2421214A, for example, shows a jigsaw with an additional part in the form of a vertically adjustable saw table. The additional vertically adjustable saw table can be fastened onto the existing saw table of a jigsaw and enables the cutting depth of the jigsaw to be adjusted.

It has proved to be a disadvantage that the result of adjusting the cutting depth of the jigsaw by vertically adjusting the saw table is that the saw blade runs in a considerably more irregular manner, which makes precise work using the jigsaw difficult.

It is a further object of the invention to solve the disadvantages of the prior art, in particular to ensure that the jigsaw runs in a regular manner and to adjust the cutting depth of the saw blade.

This object is achieved by the device defined in claim 9. Further embodiments are produced from the dependent claims.

An embodiment of a jigsaw as claimed in the invention, which is advantageous on its own per se or in combination with the aforementioned embodiment, includes a saw blade receptacle which is fixable in a releasable manner in at least two operating positions to a drive of the jigsaw, in particular to a moveable intermediate element that is connected to the drive. The operating positions, in this case, are arranged one above the other in the reciprocating direction of the jigsaw receptacle. This means that it is possible to use one jigsaw blade at different positions of the saw blade, in particular if said blade is used in the majority of cases to saw thin workpieces. Consequently, the service life of a saw blade can be increased in a considerable manner. By the saw blade receptacle being adjusted and not the height of the saw table, the saw blade continues to be guided in the usual manner close to the workpiece. Consequently, the jigsaw does not run in an irregular manner.

An alternative embodiment of a jigsaw, which is advantageous on its own per se or in combination with the aforementioned embodiment, includes a saw blade receptacle which is releasably fixable in a park position which is non-movable in relation to the housing of the jigsaw. In particular for transport, it has proved advantageous for the mechanism of the drive of the jigsaw to be able to be protected if the saw blade receptacle can be decoupled from the drive.

In addition, the park position can be arranged such that the saw blade is situated substantially completely in the interior of the housing. In this case, the term substantially completely in the interior of the housing refers to the fact that the saw blade does not protrude beyond the saw table. It is conceivable for the jigsaw to have a plurality of park positions in order to accommodate jigsaw blades of different lengths. However, the park position can also be arranged such that only commercially available standard saw blades can be completely drawn in. It goes without saying that such an arrangement of the park position, or of the saw blade receptacle and of the saw blade, reduces the risk of injuries enormously in the case of improper operation.

The saw blade receptacle can have a movable connecting means, by means of which the saw blade receptacle, in the operating positions, is connectable to a receptacle device which is arranged on the intermediate element or, in the park position, is connectable to a receptacle device which is connected to the housing. The combination of connecting means and receptacle device enables a secure and simple connection in the operating position to the intermediate element or in the park position to the housing. In addition, the connecting means can be designed such that it can be operated without tooling. The connecting means can be designed as a pin for example, engaging in the receptacle devices, for example, in the form of recesses in the intermediate element and thus securing the connection. The housing or an additional auxiliary part can equally be designed with a corresponding receptacle device. Other combinations of connecting means and receptacle devices are also conceivable.

The connecting means can be pretensioned in the direction of the receptacle device by way of a locking spring such that unintentional releasing out of the operating positions or the park position is prevented. At the same time, a suitable design of the intermediate element and of the recess can achieve for the park position that a saw blade receptacle, the connecting means of which is not locked correctly in an operating position, is pushed into the park position by the movement of the intermediate element and is automatically locked there. Consequently, an additional safety measure is created protecting thoughtless persons from injuries caused by the moved saw blade.

The saw blade receptacle can be movably mounted by means of at least one guide element. Additionally guiding the saw blade receptacle can prevent the bearing arrangement of the movable intermediate element from being excessively loaded. Thus, for example, the saw blade receptacle can be mounted on a carriage which is connected moveably to the housing by means of its own bearing arrangement. Such a bearing arrangement can be, for example, a sleeve bearing/guide rod combination. Other embodiments of a movable bearing are equally conceivable.

The jigsaw can additionally include an operating element which juts out of the housing at a fixed position. The operating element is designed such that it is movable into contact with the connecting means independent of the position of the saw blade receptacle and enables displacement of the connecting means. This means that it is possible to make adjustments to the operating position or to make adjustments in the park position in every position of the saw blade receptacle. The operating element preferably juts out of the housing on the side opposite the actuating element for operating the wedge.

In the prior art, DE7338651U, for example, shows a jigsaw with a saw table which can be displaced rearward during the sawing process in opposition to a spring force. A disadvantage of this device is that it is certainly possible to displace the saw table during the sawing process, but this possibility of displacement is only possible by releasing a screw connection using a tool. The screw connection also has to be operated using a tool once again for the fixing process.

It is another object of the invention to solve the disadvantages of the prior art, in particular to make possible displacing and fixing the saw table without any tooling.

This object is achieved by the device defined in claim 16. Further embodiments are produced from the dependent claims.

An alternative embodiment of a jigsaw, which is advantageous on its own per se or in combination with the aforementioned embodiments, includes a saw table which is displaceable in the direction of sawing in relation to a housing of the jigsaw between a front position and a rear position. Consequently, when placed against the edge of a workpiece, for example, the saw table can be adjusted forward such that it protrudes beyond the cutting edge of the saw blade and enables the jigsaw to be supported on the workpiece before the saw blade engages in the workpiece. This means that precise work is facilitated. If, however, sawing has to take place with the jigsaw as far as up to an edge or a shoulder, the saw table can be adjusted, for example, into a rear position such that said jigsaw is flush with the cutting edge of the saw blade. The saw table can be connected to the housing, for example by means of a T-rail. This means that, where required, the saw table can also be replaced by another saw table. The T-rail can have a stop member in each of the front and rear positions such that unlocking the saw table is prevented. At the same time, said stop member can define the front and the rear position. The saw table can be automatically lockable in a rear position. Said locking can be designed, for example, such that, during sawing, the saw table, by impacting against an edge or a shoulder during the sawing process, can be pushed into the rear position, where it is then automatically locked. Other types of guiding are also conceivable in place of guiding by means of a T-rail.

The saw table can have an unlocking pin which enables a release in the rear position. This means that adjustment into the front position can be effected without the use of tooling. The mentioned unlocking can also be effected by means of the unlocking pin at the same time.

The saw table itself can be pretensioned into the front position by way of a spring. Consequently, the saw table has to be pressed in opposition to the spring force into the rear position, where it then locks. This locking can be effected, for example, by way of the unlocking pin. To this end, the unlocking pin can be pretensioned, for example, by means of a spring and, in the rear position of the saw table, can lock in a recess of the housing of the jigsaw. As an alternative, however, the unlocking pin can also be fitted on the housing of the jigsaw and can engage, pretensioned by the spring, in a slot in the saw table. Said slot can have a widening at its front end such that, when the rear position is reached, the unlocking pin penetrates in said widening and blocks any further movement, in particular displacement into the front position of the saw table. For release, the unlocking pin can be pressed such that said pin engages in the slot again and the saw table is pressed forward by the spring. A damping element, for example in the form of a rubber buffer, can be incorporated in the front position, smoothly absorbing the mass of the saw table accelerated by the spring. By arranging the unlocking pin in a suitable manner, the saw table can even be adjusted during the sawing process.

The invention is explained below by way of the figures, which purely show exemplary embodiments and in which, in detail:

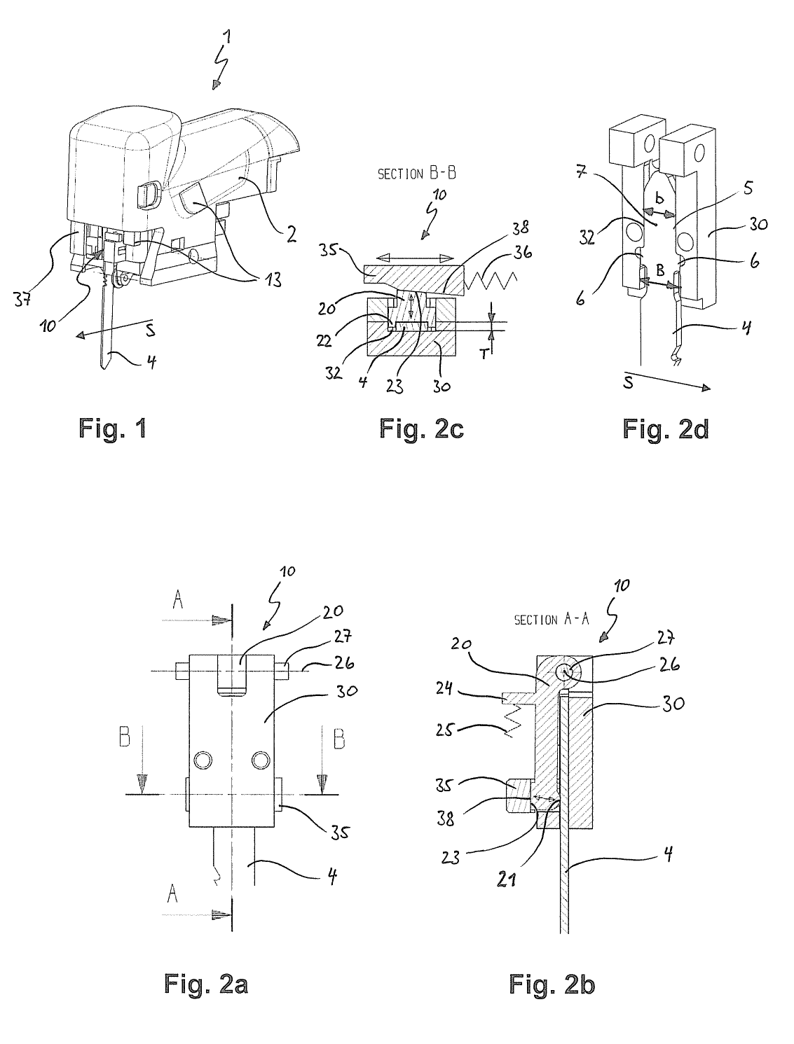

FIG. 1: shows a jigsaw as claimed in the invention without a saw table,

FIG. 2a: shows a side view of the saw blade receptacle in FIG. 1,

FIG. 2b: shows a section along the plane A-A in FIG. 2a,

FIG. 2c: shows a section along the plane B-B in FIG. 2a,

FIG. 2d: shows an isometric representation of the counter piece with a saw blade,

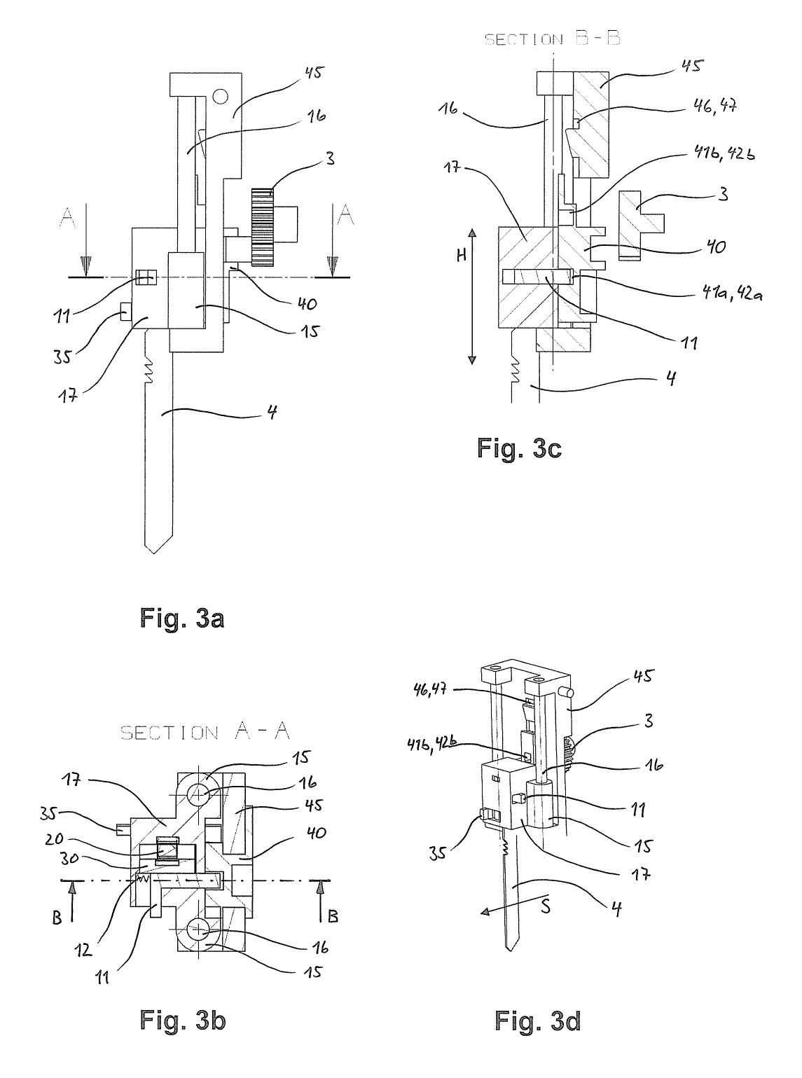

FIG. 3a: shows a side view of the saw blade receptacle with carriage and drive from FIG. 1,

FIG. 3b: shows a section along the plane A-A in FIG. 3a,

FIG. 3c: shows a section along the plane B-B in FIG. 3b,

FIG. 3d: shows an isometric representation of the saw blade receptacle with carriage and drive in FIG. 3a,

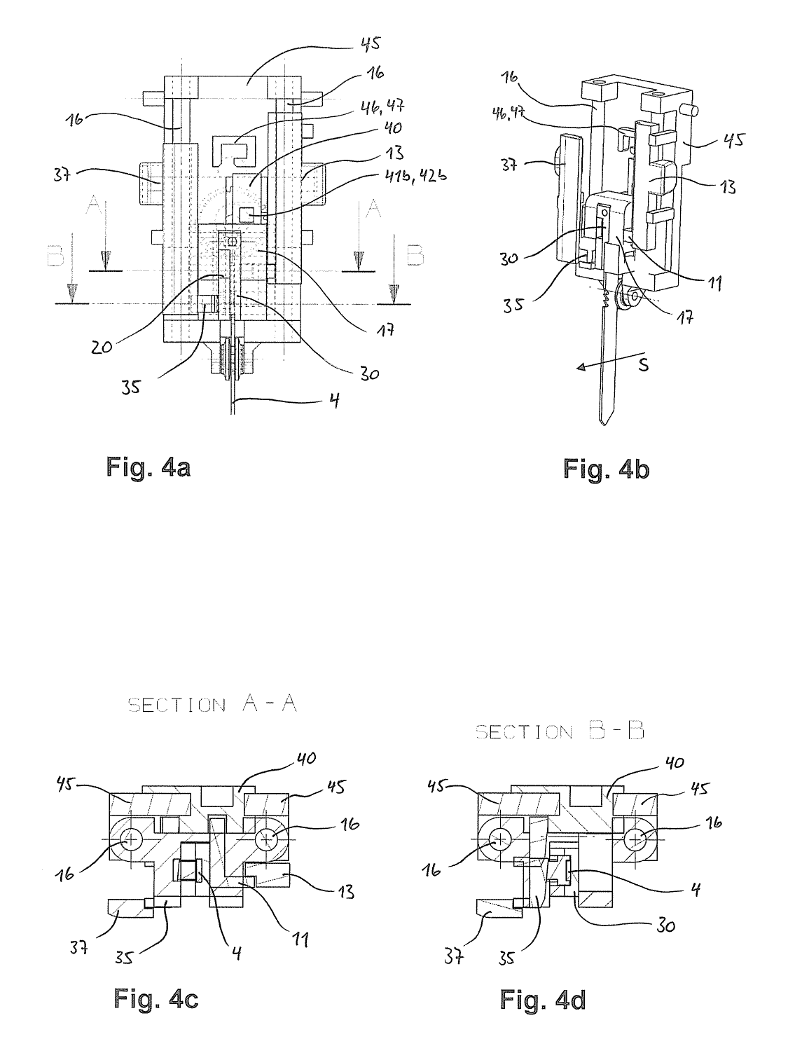

FIG. 4a: shows a front view of the saw blade receptacle with carriage, intermediate element, operating and actuating element from FIG. 1,

FIG. 4b: shows an isometric representation of the saw blade receptacle with carriage, intermediate element, operating and actuating element in FIG. 4a,

FIG. 4c: shows a section along the plane A-A in FIG. 4a,

FIG. 4d: shows a section along the plane B-B in FIG. 4a,

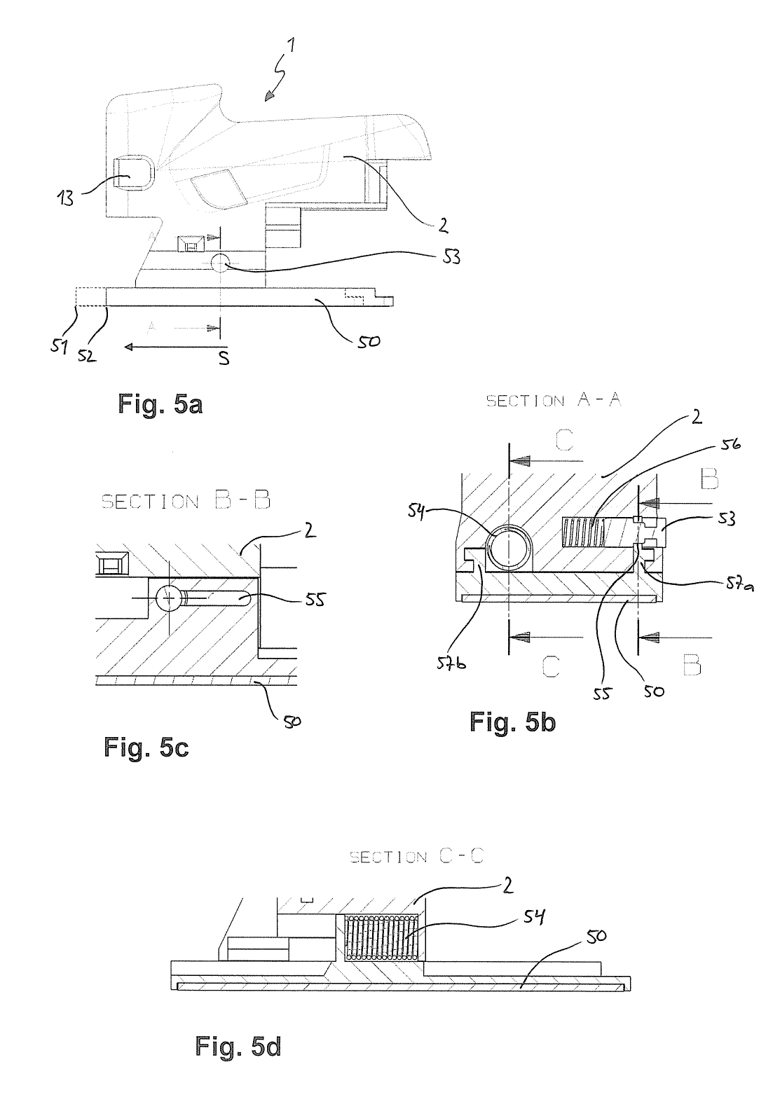

FIG. 5a: shows a side view of a jigsaw as claimed in the invention,

FIG. 5b: shows a section along the plane A-A in FIG. 5a,

FIG. 5c: shows a section along the plane B-B in FIG. 5b,

FIG. 5d: shows a section along the plane C-C in FIG. 5b.

FIG. 1 shows a jigsaw 1 as claimed in the invention, the saw table having been removed. The housing 2 has in the direction of sawing S at the side an operating element 13, which juts out of the housing 2. In the direction of sawing S at the front end of the jigsaw 1, the housing 2 has an opening where a saw blade receptacle 10 and an actuating element 37 for releasing a saw blade 4 and the operating element 13 for adjusting the saw blade receptacle can be seen.

The saw blade receptacle 10 is shown in detail in FIGS. 2a to 2d. The saw blade receptacle 10 essentially consists of a clamping element 20, a counter piece 30 and a wedge 35, which presses the clamping piece 20 against the counter piece 30. The clamping element 20 is fastened on the counter piece 30 by way of a pin 27 and can be pivoted about the axis 26.

A saw blade 4 is accommodated by way of its shaft 5 in a groove-shaped shaft receptacle 32 in the counter piece 30. In this case, the width B of the shaft receptacle 32 is selected such that it corresponds approximately to the width b of the shaft 5. Play that is present between the width B of the shaft receptacle 32 and the width b of the shaft 5 is of no consequence to the operation of the jigsaw as, in this case, the play is in the direction of sawing S. The depth T of the shaft receptacle 32 corresponds approximately to the thickness of commercially available jigsaw blades 4. An exact match is not necessary in this case because the clamping element 20 presses onto the flat side 7 of the shaft 5 and thus compensates for any tolerance fluctuations. At the same time, precise working is ensured.

The clamping element 20 has a specially formed contact surface 21, which ensures contact with the shaft 5 of the saw blade 4. In the example shown in FIG. 2b, the contact surface 21 is protruding in part in the shape of a cylinder. As can be seen in FIG. 2c, the clamping element 20 has a projection 22 on each side of the contact surface, said projection engaging behind a cam 6 on the shaft 5. It is thus possible to ensure that the saw blade 4 is not able to slip inadvertently out of the saw blade receptacle 32. The projections 22 are positioned such that they match the cams 6 of the shafts 5 of commercially available jigsaw blades. The exemplary embodiment shown is a jigsaw blade 4 with a single cam shaft or T-shaft.

The wedge 35 is horizontally displaceable and acts by way of its wedge surface 38 on a sliding surface 23 of the clamping element 20. The wedge 35 is obviously mounted in a guided manner on the opposite side, which is, however, not shown. The wedge 35 is pretensioned by way of a wedge spring 36 such that said wedge, in the normal state, presses onto the clamping element 20 and the saw blade receptacle 20 is closed.

The clamping element 20 in FIG. 2b has a spring stop member 24, on which an opening spring 25 acts. The opening spring 25 is connected (not shown) to the counter piece 30 at its end opposite the spring stop member 24 and brings about an automatic opening of the clamping element 20 as soon as the wedge 35 is pushed to the side. Consequently, a saw blade 4 can be removed or inserted in a force-free manner. Alternative solutions are conceivable, thus for example, the clamping element 20 can also be connected to the wedge 35 by means of a guide connecting member such that the displacement of the wedge 35 brings about an opening of the clamping element 20.

The materials of the wedge 35 and of the clamping element 20, as well the angle of the wedge surface 38 and of the sliding surface 23 are selected such that they slide on each other in as friction-free a manner as possible. In the exemplary embodiment shown, the angles are each 5°, the wedge 35 and the clamping element 20 are produced from steel, preferably hardened steel. Other material combinations, in particular with different materials used for the wedge and the clamping element, and other angles are conceivable.

FIGS. 3a to 3d show the saw blade receptacle 10 installed in a carriage 17. The carriage 17 is guided on guide rods 16 of a base 45 by means of a guide element 15 in the form of a sliding bearing. The carriage 17 is releasably connected to a movable intermediate element 40. The intermediate element 40 is guided movably on the base 45 and is connected to the drive 3 of the jigsaw. Consequently, the carriage 17, the saw blade receptacle 10 and also the saw blade 4 carry out the movement predetermined by the drive 3.

As shown in FIG. 3c, the carriage 17 is connected to the intermediate element 40 in a first operating position 41a by way of a connecting means 11, which protrudes laterally out of the carriage by way of its one end and engages in a first receptacle device 42a by way of its other end. In the exemplary embodiment shown, the intermediate element 40 has two operating positions 41a, 41b arranged one above the other in the direction of the reciprocating movement H of the saw blade 4 and, in a corresponding manner, two receptacle devices 42a, 42b; a different number, however, is equally conceivable. The connecting means 11 is in the form of a pin. The receptacle devices 42a, 42b are designed in a corresponding manner as recesses. Other developments are conceivable. The connecting means 11 is pretensioned by way of a locking spring 12 (see FIG. 3b) such that it rests securely in a receptacle device 42a, 42b of the intermediate element 40 defining the operating position 41a, 41b. The connecting means 11 can be pulled out of the receptacle device 42a of the intermediate element 40 in opposition to the spring force of the locking spring 12, which allows displacement of the carriage 17 into, for example, the second operating position 41b. Consequently, when the jigsaw 1 is next used, the same region of the saw blade 4 is no longer in use. In particular when sawing thin workpieces, this can double the service life of the saw blade 4.

The base 45, which is fixedly connected to the housing 2 of the jigsaw 1, has a receptacle device 47, which corresponds to a park position 46 and in which the connecting means 11 can lock. In the exemplary embodiment shown, this is a slot-like recess. This park position 46 is situated at a spacing above the two operating positions 41 such that the carriage 17 with the saw blade receptacle 10 can be pushed to such an extent into the housing and fixed there that the saw blade 4 no longer passes through a saw table. Naturally, in this park position 46, the saw blade receptacle 10 is no longer coupled to the drive 3 such that actuating the drive 3 does not represent a danger. The base 45 has a ramp in the region of the receptacle device 47 such that the connecting means 11, if not resting on the intermediate element 40, is automatically pushed into the receptacle device 47 of the park position 46 when the drive 3 is actuated.

The wedge 35 protrudes out of the carriage 17 in the direction of sawing on the front side of the carriage 17 such that operation of the saw blade receptacle 10, or releasing the clamping element 20 from the counter piece 30, is made possible.

FIGS. 4a to 4d show the saw blade receptacle 10 installed in the carriage 17 with the intermediate element 40, an operating element 13 and an actuating element 37 for the wedge 35 and the connecting means 11. In addition, the base 45 with the two guide rods 16 can also be seen.

In the direction of sawing on the left next to the carriage 17 there is an operating element 13, by means of which the connecting means 11 can be moved in opposition to the force of the locking spring 12 (see FIG. 3b). In the exemplary embodiment shown, the operating element 13 engages behind the connecting means 11 (see FIG. 4c). The operating element 13 extends above the entire lifting height of the carriage 17 such that in each position of the carriage 17, it is possible to release the connecting means 11 from the receptacle devices 42a, 42b, 47 of the operating positions 41a, 41b or the park position 46. Approximately in its center, the operating element 13 has a knob-shaped bulging which projects through the housing of the jigsaw (not shown) and consequently, enables actuation of the operating element 13 from outside the housing.

An actuating element 37 is arranged in the direction of sawing on the right next to the carriage 17. Said actuating element 37 allows the wedge 35 protruding out of the carriage 17 to be pressed in opposition to the force of the wedge spring. The actuating element 37 also extends above the entire region of the lift of the carriage 17. Consequently, the wedge 35 can be actuated in any position of the carriage 17 such that the clamping element 20 is released from the counter piece 30 in the direction of the arrow (see FIG. 4d) and releases the saw blade 4.

FIGS. 5a to 5d show the jigsaw 1 and details of the saw table 50. The saw table 50 is displaceable in the direction of sawing S in relation to the housing 1 so as to be movable between a front position 51 and a rear position 52. FIG. 5a shows these two positions 51, 52, the front position 51 being shown by a dot dash line. The operating element 13 for actuating the connecting means is also visible in this figure. An unlocking pin 53 is used for releasing the saw table 50 out of the rear position 52. The saw table 50 is fastened on the housing 2 by means of two T-rails 57a, 57b and is pretensioned into the front position 51 by way of a spring 54 (see FIG. 5d). Other types of guiding are equally conceivable. A lateral slot 55 in the T-rail 57a, together with an unlocking pin 53 that engages therein, serves as a front and rear stop member.

The unlocking pin 53 rests in a recess in the housing 2 of the jigsaw 1 and is pressed against the T-rail by way of a locking spring 56 (see FIG. 5b). At the same time, it engages in the slot 55. The slot 55 is widened at its front end, corresponding to the rear position 51 of the saw table, such that there is space for part of the unlocking pin 53. When the rear position 52 of the saw table 50 is reached, the unlocking pin 53 is pressed in part into the widened slot by means of the locking spring 56 such that the saw table 50 locks in this position 52. To release the locking and to adjust the saw table 50 into the front position 51, the unlocking pin 53 has to be pressed until said pin can once again engage in the slot 55. The carriage is then automatically displaced into the front position 51 by means of the force of the spring 54. A damping element in the form of a rubber buffer (not shown) is incorporated in the front position 51, said damping element smoothly absorbing the mass of the saw table accelerated by the spring.

1-18. (canceled)

19. A jigsaw having a saw blade receptacle for fastening a saw blade to the jigsaw without a tool,
wherein the saw blade receptacle includes a clamping element, a counter piece and at least one wedge which is in operative connection with the clamping element,
wherein, by means of displacement of the wedge, the clamping element is movable against a shaft of the saw blade which is positionable between clamping element and counter piece,
wherein the wedge is displaceable approximately perpendicular to the direction of movement of the saw blade.

20. The jigsaw as claimed in claim 19,
wherein the clamping element is positioned such that a contact surface of the clamping element is movable against a flat side of the shaft of the saw blade.

21. The jigsaw as claimed in claim 19,
wherein the clamping element is fastened on the counter piece so as to be rotatable about an axis.

22. The jigsaw as claimed in claim 21,
wherein the axis extends approximately parallel to the flat side of the shaft of the saw blade in the operating position and approximately perpendicular to the direction of movement of the saw blade.

23. The jigsaw as claimed in claim 19,
wherein the clamping element is fastened on the counter piece such that the clamping element is automatically moved into an open position with the wedge pushed away.

24. The jigsaw as claimed in claim 20,
wherein the clamping element, on the side of the contact surface, has at least one projection which projects beyond the contact surface.

25. The jigsaw as claimed in claim 19,
wherein the counter piece has a groove-shaped shaft receptacle, which in its width corresponds approximately to the width of the shaft of the saw blade.

26. The jigsaw as claimed in claim 19,
wherein the jigsaw additionally includes an actuating element, which juts out of the housing at a fixed position and is movable into contact with the wedge independently of the position of the saw blade receptacle and consequently enables displacement of the wedge.

27. A jigsaw having a saw blade receptacle,
wherein the saw blade receptacle is fixable in a releasable manner in at least two operating positions to a drive of the jigsaw.

28. The jigsaw as claimed in claim 27,
wherein the saw blade receptacle is fixable to a moveable intermediate element connected to the drive.

29. A jigsaw having a saw blade receptacle,
wherein the saw blade receptacle is releasably fixable in a park position which is non-movable in relation to the housing of the jigsaw.

30. The jigsaw as claimed in claim 29,
wherein the park position is arranged in such a manner that the saw blade is situated substantially completely in the interior of the housing.

31. The jigsaw as claimed in claim 29,
wherein the saw blade receptacle has a movable connecting means, by means of which the saw blade receptacle, in one of the operating positions, is connectable to a receptacle device which is arranged on the intermediate element or, in the park position, is connectable to a receptacle device which is connected to the housing.

32. The jigsaw as claimed in claim 31,
wherein the connecting means is pretensioned in the direction of the receptacle device by way of a locking spring.

33. The jigsaw as claimed in claim 27,
wherein the saw blade receptacle is movably mounted by means of at least one guide element.

34. The jigsaw as claimed in claim 31,
wherein the jigsaw additionally includes an operating element which juts out of the housing at a fixed position and is movable into contact with the connecting means independent of the position of the saw blade receptacle and consequently enables displacement of the connecting means.

35. A jigsaw having a saw table,
wherein the saw table is displaceable in the direction of sawing in relation to a housing of the jigsaw between a front position and a rear position,
wherein the saw table is automatically lockable in the rear position.

36. The jigsaw as claimed in claim 35,
wherein the saw table has an unlocking pin for releasing the saw table from the rear position.

37. The jigsaw as claimed in claim 35,
wherein the saw table is pretensioned into the front position by way of a spring.
